(19) United States
(12) Patent Application Publication
(10) Pub. No.: US 2013/0103576 A1
(43) Pub. Date: Apr. 25, 2013

(54) TRANSACTION MANAGEMENT SYSTEM AND METHOD

(71) Applicant: Ollie Ackley, St. Charles, MO (US)

(72) Inventor: Ollie Ackley, St. Charles, MO (US)

(21) Appl. No.: 13/277,529

(22) Filed: Oct. 20, 2011

(51) Int. Cl. G06Q 20/10

(52) U.S. Cl. 705/39

(57) ABSTRACT

A method for managing a transaction includes receiving merchant information. Then a merchant account may be established with the merchant information. Consumer information may also be received whereby a consumer account may be established. The consumer and merchant may then be associated. Payment instructions may be received and the merchant account may be credited in the amount from the payment instructions.

### BACKGROUND OF INVENTION

This application relates generally to managing transaction and more particularly to systems and methods for electronically managing transactions.

### SUMMARY

Business transactions are increasingly being done over the internet. While point of sale transactions include the use of the internet for the purposes of processing credit or debit card payments, these transaction still frequently require physical cards, physical receipts and the like. Therefore, there is a significant need to further manage these transactions electronically to enhance security, increase the speed and eliminate the need for physical items such as plastic credit or debit cards, paper receipts, etc.

In one embodiment, a computer implemented method comprises: receiving merchant information; establishing a merchant account with the merchant information; receiving consumer information; establishing a consumer account with the consumer information; receiving a merchant connection request from a consumer terminal; associating the consumer terminal with the merchant; receiving payment instructions from the consumer terminal; and crediting the merchant account with an amount from the payment instructions.

In another embodiment, a transaction management device comprises: a memory configured to store a set of instructions; and a processor configured to execute the set of instructions, wherein the set of instructions cause the processor to: receive merchant information; establish a merchant account with the merchant information; receive consumer information; establish a consumer account with the consumer information; receive a merchant connection request from a consumer terminal; associate the consumer terminal with the merchant; receive payment instructions from the consumer terminal; and credit the merchant account with an amount from the payment instructions.

In yet another embodiment, a transaction management system comprises: one or more terminals operable to act as a client on a network; a computer operable to act as a server on the network and to communicate with each of the participant terminals over the network, the computer comprising: a memory configured to store a set of instructions; and a processor configured to execute the set of instructions, wherein the set of instructions cause the processor to: receive merchant information; establish a merchant account with the merchant information; receive consumer information; establish a consumer account with the consumer information; receive a merchant connection request from a consumer terminal; associate the consumer terminal with the merchant; receive payment instructions from the consumer terminal; and credit the merchant account with an amount from the payment instructions.

### BRIEF DESCRIPTION OF THE DRAWINGS

The drawings, when considered in connection with the following description, are presented for the purpose of facilitating an understanding of the subject matter sought to be protected.

FIG. 1 is an illustration of a transaction coordination network; and

FIG. 2 is a flow diagram of an illustrative process for coordinating a transaction.

### DETAILED DESCRIPTION

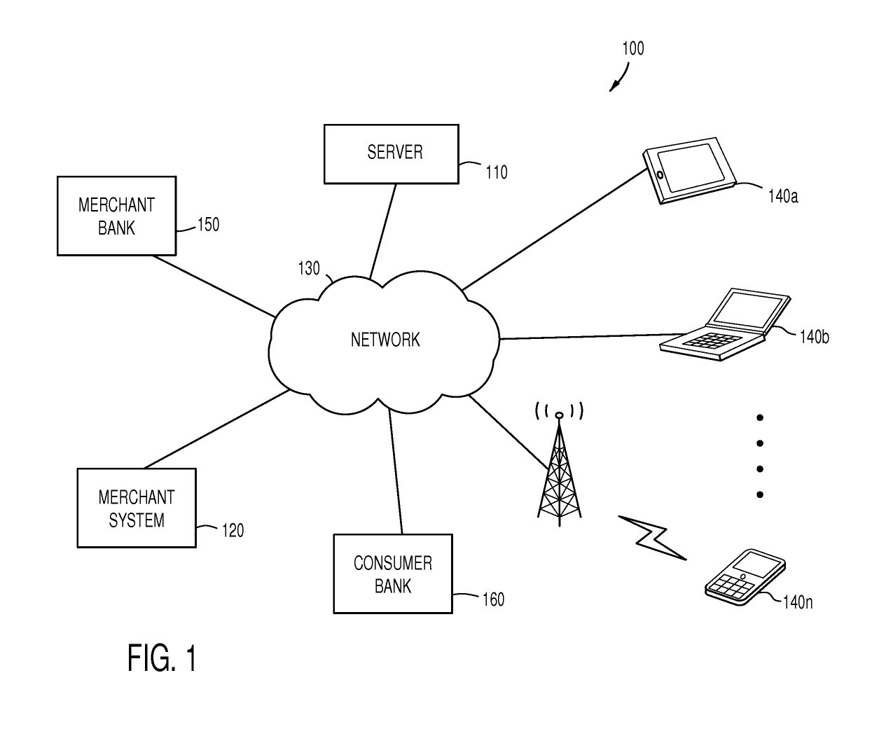

Referring now to FIG. 1, a payment system 100 is depicted. The system 100 may include a server 110, merchant system 120, a communications network 130, and one or more participant terminals 140a-140n (collectively 140). The system may also include communications with a merchant bank 150 and/or consumer bank 160. The different elements and components of the system 100 may communicate with one another using wireless communications or hardwired connections, such as fiber optics, cable, DSL, telephone lines, and other similar connections.

The communications network 130 may include any number of networks capable of providing communications between the server 110, and terminals 140. For example, the communications network may be one or more, or any combination of, wireless networks, data or packet networks, publicly switched telephone networks (PSTN), etc.

The participant terminals 140 may include any suitable device operable to act as a client on a network. Illustrative terminals 140 include, but are not limited to, personal computers, desktop computers, laptop computers, tablet computers, servers, or any suitable telecommunications device, including, but not limited to, VoIP telephones, smart telephones or wireless devices, such as cellular telephones, personal digital assistants (PDA), communications enabled mp3 players, etc. Each terminal 140 may be configured to transmit and/or receive information to and/or from the server 110 and/or other participant terminals 140.

The server 110 may be any server, computer or device configured to process commands from the participant terminals 140 and/or merchant system 120. For example, the server 110 may receive merchant information for establishing a merchant account on the server 110. In one embodiment, the merchant information may be communicated from the merchant system 120, but it will be appreciated that the merchant account may be established in any suitable manner. In one illustrative embodiment, the merchant information includes account information at a financial institution 150 such that funds from a transaction may be deposited in the merchant's financial institution account. Similarly, the server 110 may receive consumer information from a terminal 140 for establishing a consumer account on the server 110; however, it will be appreciated that the consumer information may be communicated to the server 110 by any suitable means and remain within the scope of the present disclosure, further, the term “consumer” as used throughout this disclosure shall mean a purchaser who may be an individual or legal entity. In one illustrative embodiment, the consumer information includes account information at a financial institution 160 such that funds from a transaction may be withdrawn from the consumer's financial institution account for deposit at the merchant's financial institution 150.

Once the consumer's account is established on the server 110, the consumer and/or consumer's terminal 140 may be associated with a merchant. Associating a consumer or consumer terminal 140 with a merchant may allow the consumer or consumer terminal to perform transactions with the merchant. In one embodiment, the merchant may confirm the consumer before the consumer and/or consumer terminal 140 may be associated with the merchant. In an alternative embodiment, the consumer and/or consumer terminal 140 may be associated with the merchant at the discretion of the consumer. Transactions may include, without limitation, the purchase of goods or services, the rental of goods or services, or any other suitable transaction between two or more parties. The consumer and/or consumer's terminal may be associated with a merchant in any suitable manner. For example, and without limitation, a unique identifier, such as a small client or other suitable identifier, may be downloaded to the consumer's terminal 140 that permits the consumer to perform transactions with the merchant's system 120. Alternatively, a merchant and/or merchant's system 150 may identify suitable consumers and/or consumer terminals 140 for the server 110 whereby the merchant identified consumers and/or terminals 140 may be permitted to perform transactions with the merchant. Other suitable methods and techniques for associating consumers and/or terminals 140 with a merchant will be readily apparent to those skilled in the art and are expressly contemplated herein.

Once the consumer and/or terminal 140 are associated with a merchant, the consumer may transact business with the merchant. For example the merchant or merchant system 120 may communicate an amount due to the consumer and/or consumer terminal 140. The merchant may simply notify the consumer of the amount due as is typically done at any point-of-sale terminal. Alternatively, the amount due may be communicated directly from the merchant system 120 to the consumer terminal 140 via an electronic communication (e.g., Bluetooth® or any other suitable protocol), RFID, barcode to be scanned by the terminal 140 or any other suitable means or technique for communicating an amount due to the consumer and/or consumer terminal 140.

The consumer terminal 140 may be configured to communicate payment instructions to the server 110. The server 110 may be configured to verify the authenticity of the consumer employing any suitable technique known in the art, including but not limited to passwords, cookies, biometric verification or any other suitable technique or means. The server 110 may be configured to verify payment and notify the merchant system 120 that it has received payment instructions from consumer terminal 140. The server 110 may also be configured to securely coordinate electronic payment from the consumer bank 160 to the merchant bank 150. The server 110 may coordinate payments in any suitable manner. In one non-limiting example, the server 110 may employ existing credit card payment infrastructure, ACH, Check21, or any other suitable technique and/or infrastructure.

The server 110 may also provide output files or otherwise generate bookkeeping materials for the consumer and/or merchant. Illustrative transaction management and reporting options include, without limitation, Conversion Only, Verification with Conversion; Guarantee with Conversion, output files, return notification, returns re-presentment, retrieval request, refunds, credits, eChecks and statistic showing consumer product preferences, etc.

In the illustrative embodiment, the server 110 and merchant system 120 each include a memory and a processor to accommodate the forgoing. In one embodiment, the merchant system 120 includes a point of sale system. However, it will be appreciated that the forgoing may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

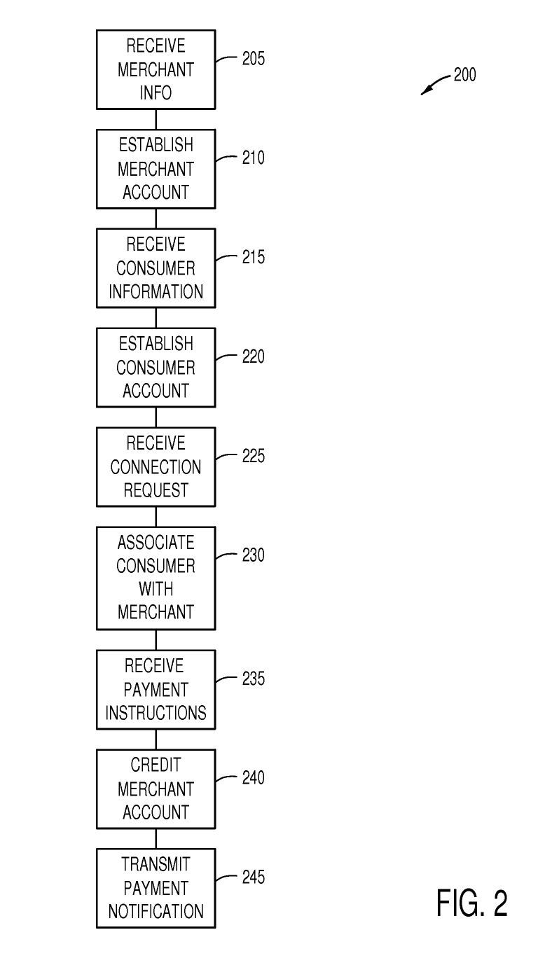

Referring now to FIG. 2, a flowchart 200 of a method of coordinating or managing a transaction is shown. The method may be implemented by a server, computer, wireless device, VoIP telephone, other advanced intelligence network device, or any combination thereof, generally referred to herein as the “device.”

First, the device may receive merchant information 205 from which the device may establish a merchant account 210. The device may also receive consumer information 215 from which the device may establish a consumer account 220. Once the respective accounts are established, the device may receive a connection request from a consumer 225 whereby the consumer seeks to be associated with a merchant such that the consumer may transact business with a particular merchant. The consumer may then be associated with a merchant thereby allowing the consumer to perform transactions with the merchant 230. In one embodiment, the merchant may confirm the consumer before the consumer is associated with the merchant. In an alternative embodiment, the consumer may be associated with a merchant at the discretion of the consumer.

Once a transaction is in process, the device may receive payment instructions from a consumer 235. The device may verify the payment instructions with the consumer via a password, cookie, biometric verification or any other suitable means or technique for confirming or verifying an instruction. Once the payment instructions are received, and optionally verified, the merchant account may be credited 240. The device may communicate debit and/or credit information to respective consumer and merchant financial institutions such that the consumer's account is debited the appropriate amount and the merchant's account credited the appropriate amount. Once the merchant account has been credited, the device may transmit a payment notification to the merchant so that the merchant is notified that the merchant account has been credited in relation to a particular transaction.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

1-6. (canceled)

7. A transaction management device comprising:
a memory configured to store a set of instructions and information; and
a processor configured to receive and execute the set of instructions, wherein the set of instructions cause the processor to:
receive merchant information and payment and non-payment instructions;
establish a merchant account with the merchant information and instructions;
receive consumer information and payment and non-payment instructions;
establish a consumer account with the consumer information;
receive a merchant connection request from a consumer terminal;
associate the consumer terminal with the merchant by transmitting a unique merchant identifier to the consumer terminal;
receive payment instructions from the consumer terminal;
receive additional transaction instructions from the merchant account;
receive additional transaction instructions from the consumer account; and;
credit the merchant account with an amount from the payment instructions and exchange both consumer and merchant non-payment instructions.

8. The device of claim 7 wherein the instructions further cause the processor to associate an account at the merchant's financial institution with the merchant account whereby funds are credited to the financial institution merchant account.

9. The device of claim 7 wherein the instructions further cause the processor to associate an account at a the consumer's financial institution with the consumer account whereby funds are debited from the financial institution consumer account upon receiving payment instructions.

10. (canceled)

11. The device of claim 7 wherein the instructions further cause the processor to transmit a payment notification to the consumer terminal together with the additional instructions from the merchant.

12. The device of claim 7 wherein the instructions further cause the processor to transmit a payment notification to the merchant together with the additional instructions from the consumer.

13. A transaction management system comprising:
one or more terminals operable to act as a client on a network;
a computer operable to act as a server on the network and to communicate with each of the participant terminals over the network, the computer comprising:
a memory configured to store a set of instructions;
a database to store information; and
a processor configured to execute the set of instructions pursuant to the instructions, wherein the
set of instructions cause the processor to:
receive merchant information;
establish a merchant account with the merchant information and merchant instructions for a given consumer or all consumers in general;
receive consumer information;
establish a consumer account with the consumer information and consumer instructions for a given merchant or all merchants in general;
establish a secure connection internal to the transaction management system to exchange information and instructions;
receive a merchant connection request from a consumer terminal;
associate the consumer terminal with the merchant by transmitting a unique merchant identifier to the consumer terminal;
receive payment instructions from the consumer terminal; and
credit the merchant account using any fund transfer technology with an amount from the payment instructions.

14. The system of claim 13 wherein the instructions further cause the processor to associate an account at a financial institution with the merchant account whereby funds are credited to the financial institution account.

15. The system of claim 13 wherein the instructions further cause the processor to associate an account at a financial institution with the consumer account whereby funds are debited from the financial institution account upon receiving payment instructions.

16. (canceled)

17. The system of claim 13 wherein the instructions further cause the processor to transmit a payment notification to the consumer terminal.

18. The system of claim 13 wherein the instructions further cause the processor to transmit a payment notification to the merchant.
